(19) United States
(12) Patent Application Publication
(10) Pub. No.: US 2008/0055488 A1
(43) Pub. Date: Mar. 6, 2008

(54) Video channel changing

(76) Inventor: Adil Jagmag, Nashua, NH (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/514,575

(22) Filed: Aug. 31, 2006

(51) Int. Cl. H04N 5/50

(52) U.S. Cl. 348/731

(57) ABSTRACT

A method for reducing the perceived channel change time in digital televisions systems includes receiving and decoding a first signal that includes first video streams each including a series of first images, the video streams being of frequencies in different frequency bands of available first frequency bands, receiving and decoding a second signal with second video stream indicia of the first video streams, the second signal having characteristics other than having multiple frequencies in the available first frequency bands, and responding to a digital video stream change request by selecting a portion of the indicia corresponding to a newly requested first video stream and displaying video corresponding to the selected portion of the indicia during at least a portion of a delay time from when the new first video stream is selected to when that stream is acquired, decoded and displayed.

### BACKGROUND

It is well known to one skilled in the art of digital television transmission that the compression technology that is used to achieve efficiency also makes the signals difficult to decode and display quickly. Thus, there is a delay from the time that a television tuner is first tuned to a digital television channel and the time that the video information is displayed to the viewer. The delay during a channel change can become quite intrusive or frustrating for viewers who are accustomed to the quicker channel change response of a conventional analog television receiver. Accordingly, it is desirable to reduce the perceived channel change time for a digital television viewer, and to fill the delay time with an adequate picture.

### SUMMARY

In general, in an aspect, the invention provides a digital television receiver system for reducing the perceived channel change time in digital television systems, the system includes: means for decoding a primary digital video signal that is a component of a composite signal, the primary signal having a first frequency in any of multiple bands of frequencies for conveying the composite signal which contains component digital video signals each including a primary image stream; a means for decoding a supplemental digital video signal including indicia of the image streams of the component digital video signals, the supplemental signal being at least one of the following: of a second frequency in the bands of frequencies, of a second frequency outside the bands of frequencies, and of a form for transfer in a packet-switched network; and a means for selecting and displaying a portion of the indicia corresponding to one of the image streams from the supplemental signal corresponding to a newly requested one of the component video signals.

Implementations of the invention may include one or more of the following features. The means for displaying is configured to display the selected image stream during a delay time between when a new primary signal is selected to when a digital signal is acquired, decoded and displayed. The indicia of the image streams are indicative of supplemental images of lower resolution than primary images indicated by the primary image streams, and the means for displaying is configured to size the images corresponding to the selected supplemental image stream similarly to a size of the primary images. The means for decoding the supplemental signal is configured to persistently receive and decode the supplemental signal.

In general, in another aspect, the invention provides a method for reducing the perceived channel change time in digital televisions systems, the method including receiving and decoding a first signal that includes first video streams each including a series of first images, the video streams being of frequencies in different frequency bands of available first frequency bands, receiving and decoding a second signal with second video stream indicia of the first video streams, the second signal having characteristics other than having multiple frequencies in the available first frequency bands, and responding to a digital video stream change request by selecting a portion of the indicia corresponding to a newly requested first video stream and displaying video corresponding to the selected portion of the indicia during at least a portion of a delay time from when the new first video stream is selected to when that stream is acquired, decoded and displayed.

Implementations of the invention may include one or more of the following features. Decoding the second signal includes decoding a signal of a frequency within the available primary frequency bands. Decoding the second signal includes decoding a signal of an out-of-band frequency range. Receiving the second signal includes receiving the second signal via a packet-switched network connection and decoding the second signal includes decoding packets of information in the second signal. Receiving the second signal further includes the packet switched network connection is a Transmission Control Protocol/Internet Protocol (TCP/IP) connection. The indicia of the video streams are indicative of images that are of lower video resolution than the first images indicated by the first signal. The secondary indicia from the secondary signal corresponding to a newly requested primary video stream is cropped from the secondary video stream and scaled to substantially the same size as the requested primary video stream. Receiving and decoding the second signal are performed in an ongoing manner such that the indicia are available for selection substantially simultaneously with a new first video stream being selected.

In general, in another aspect, the invention provides a digital television receiver system including a tuner configured to receive a digital data stream, a digital demodulator coupled to the tuner and configured to demodulate the digital data stream received from the tuner, a digital video decoder coupled to the demodulator and configured to decode the digital video data stream received from the digital demodulator, a display coupled to the decoder and configured to receive the decoded video stream and present the video in a viewable format, and a device coupled to the display and configured to respond to a digital television channel change indication to send to the display a lower resolution image stream of a new requested digital television channel while the tuner adjusts to a frequency of the new requested digital television channel and the decoder initially decodes the new requested digital television channel.

Implementations of the invention may include one or more of the following features. The device is configured to process a persistent, dedicated signal to produce the lower resolution image stream. The device is configured to process the persistent dedicated signal with the persistent dedicated signal having an out-of-band frequency. The device is configured to process the persistent dedicated signal having an in-band frequency. The device is configured to process the lower resolution image stream received via a packet-switched network connection. The packet switched network connection is a Transmission Control Protocol/Internet Protocol (TCP/IP) connection. The device is configured to receive and decode the persistent, dedicated signal in a substantially continuous manner.

Various aspects of the invention may provide one or more of the following capabilities. The capability to enhance the perceived responsiveness and channel change time of a digital television receiver. The time required for displaying the requested image from the index channel is reduced because an index channel is always tuned and hence no tune/demodulation time is required. Second, the quality/resolution of the image from the index channel is lower than that of the regular channel, which allows the picture decode time to be decreased.

These and other capabilities of the invention, along with the invention itself, will be more fully understood after a review of the following figures, detailed description, and claims.

### BRIEF DESCRIPTION OF THE FIGURES

FIG. 1 is a block diagram of a digital television transmission and receiver system.

FIG. 2 is a block diagram of a configuration of video frames on an index channel.

FIG. 3 is a block flow diagram of a traditional digital TV receiver.

FIG. 4 is a block flow diagram of a digital TV receiver configured to utilize an out of band index channel.

FIG. 5 is a block diagram of a process of providing an index channel.

FIG. 6 is a block diagram of a process of receiving an index channel.

FIG. 7 is a block diagram of a process of implementing a channel change.

FIG. 8 is a block diagram of a traditional digital TV receiver with a dual tuner configuration for a picture-in-picture mode.

FIG. 9 is a block diagram of a digital TV receiver with a dual tuner configuration for use with an index channel.

FIG. 10 is a block diagram of a digital TV receiver configured with an Internet connection for an index channel.

### DETAILED DESCRIPTION

The features and other details of the invention will now be more particularly described. It will be understood that particular embodiments described herein are shown by way of illustration and not as limitations of the invention. The principal features of this invention can be employed in various embodiments without departing from the scope of the invention.

Embodiments of the invention provide techniques for reducing the perceived channel change time for the viewer of a digital television system. Exemplary embodiments of the invention include the transmission of a persistent secondary channel that is a composite index channel which is divided into multiple sub-frames of audio/visual data, each frame representing an unique channel. The index channel remains tuned by the digital receiver regardless of the actual channel that the viewer is watching. When the viewer requests a channel change, the viewer is shown the lower quality image of the requested channel from the index channel during the time period of the normal channel change, at the end of which the displayed image is switched over to the regular image from the requested channel. Thus the image from the index channel, which is tuned, is shown during the time period when the viewer normally sees a blank screen during the channel change process. While the viewer watches the lower quality image from the index channel, the normal channel change process continues in parallel in the background. The use of an index channel reduces the perceived channel change time for a digital television due to multiple factors. First, the time required for displaying the requested image from the index channel is reduced because the index channel is always tuned and hence no tune/demodulation time is required. Second, the quality/resolution of the image from the index channel is lower than that of the regular channel, which allows the picture decode time to be decreased. The persistent secondary index channel can be implemented with many possible system configurations. Three examples of system configurations to implement the index channel include the utilization of an out of band transmission carrier, utilizing a known TV channel with a dual tuner receiver, and utilizing an internet connection for the index channel. Thus, the user is provided with lower quality digital images very quickly, thereby enhancing the perceived responsiveness and channel change time of the digital television system.

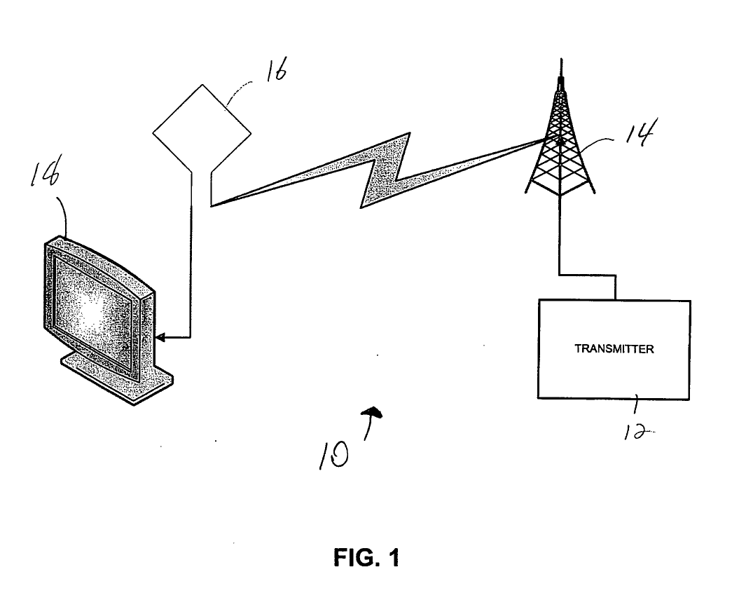

Referring to FIG. 1, a digital television transmission and receiver system 10 is shown. Although a terrestrial broadcast system is shown, a satellite or a cable system could also be used. The digital television transmission and receiver system 10 includes a digital television (DTV) signal transmitter 12, a broadcast tower 14, a individual user antenna 16, and a DTV compatible television set 18. In broadcasting, a channel is a range of frequencies (or, equivalently, wavelengths) assigned by a government for the operation of a particular broadcast station. Multiple channels of content, each with its own frequency in its own band can be transmitted together. Broadcasting is the distribution of audio and/or video signals (programs) to a number of recipients (“listeners” or “viewers”) that belong to a large group. This group may be the public in general, or a relatively large audience within the public. Television programs are distributed through radio broadcasting, satellite or cable, often in some combination simultaneously. By coding signals and having decoding equipment in homes, the latter also enables subscription-based channels and pay-per-view services. A broadcasting organization may broadcast several programs at the same time, through several channels (frequencies), for example BBC One and Two. Digital television may also transmit multiplexed programming, with several channels compressed into one ensemble.

Digital television (DTV) is a telecommunication system for broadcasting and receiving moving pictures and sound by means of digital signals, in contrast to analog signals in analog (traditional) TV. It uses digital modulation data, which is digitally compressed and requires decoding by a specially designed television set or a standard receiver with a set-top box. Modulation is the process of varying a carrier signal in order to use that signal to convey information.

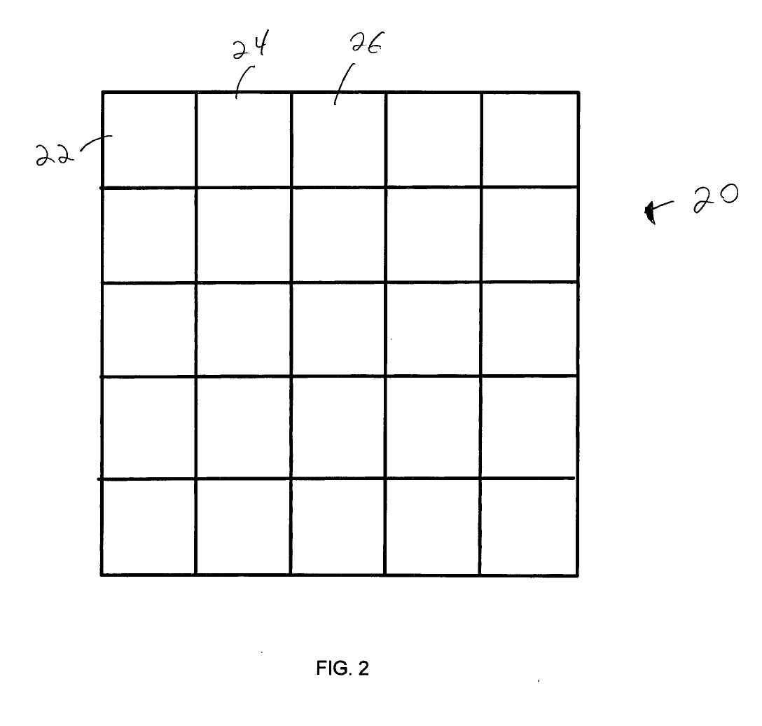

Referring to FIG. 2, an exemplary index channel 20, is shown. The index channel 20 includes video stream indicia of video images in the broadcast frequencies, e.g., sub-frames that represent/display the video from actual digital TV channels, e.g., 22, 24, and 26. Although a single exemplary index organization is shown in FIG. 2, any organization/configuration is possible with different numbers of sub-frames/channels represented and different aspect ratios of the sub-frames which would affect the picture quality as described below. The index channel 20 must be transmitted with information (meta-data) about how it is organized and the aspect ratios of the individual frames on the index channel. The metadata transmitted with the index channel 20 provides information of which sub-frame (e.g. channel 22) corresponds to the video of which digital television channel.

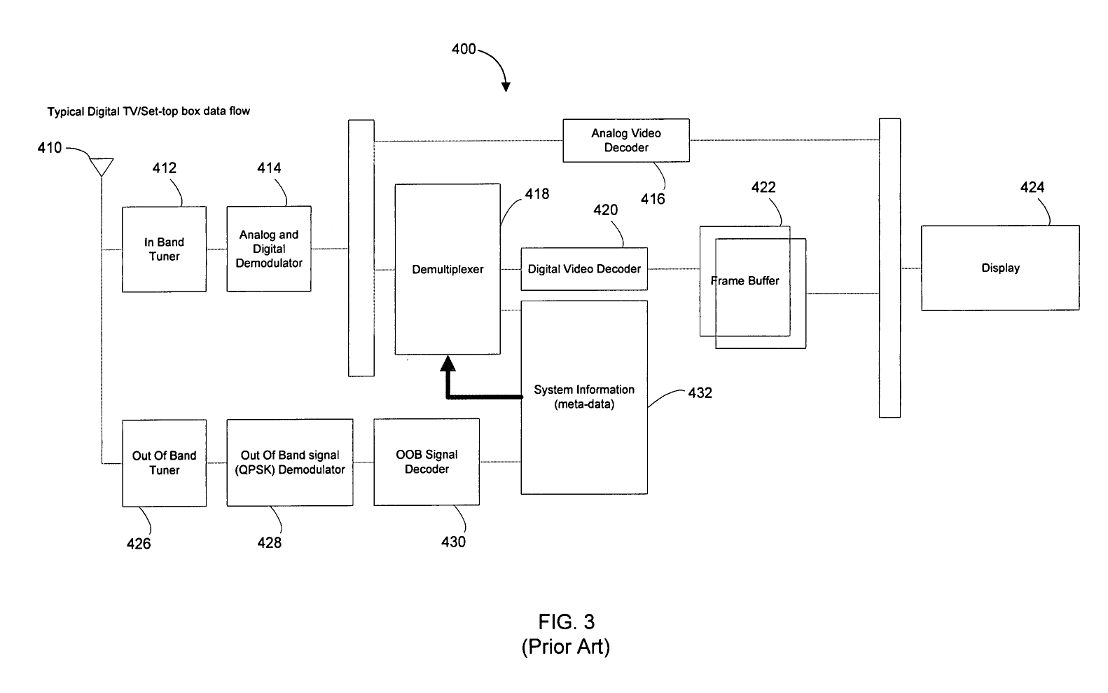

Referring to FIG. 3, a high-level functional block diagram of a conventional digital television receiving/decoding section 400 is shown. The conventional digital television receiving/decoding section 400 includes an antenna 410, an in-band tuner 412, an analog and digital demodulator 414, an analog video decoder 416, a demultiplexer 418, a digital video decoder 420, a frame buffer 422, a display 424, an out of band tuner 426, an out of band signal demodulator 428, an out of band (OOB) signal decoder 430 and a system information (meta-data) block 432. A radio frequency (RF) signal representing an MPEG data stream, is received by the antenna 410, which is electrically connected to the in-band tuner 412. Although the antenna 410 and tuner 412 are shown as receiving a broadcast digital television signal, the tuner 412 may receive cable signals or signals from a satellite receiver. The data stream is demodulated by an analog and digital demodulator 414 which is connected to the output of the in-band tuner 412. The demodulator 414 is connected through a switch to both the demultiplexer 418 and the analog video decoder 416. The demultiplexer 418 is a device that separates signals that have been combined by a multiplexer for transmission over a communications channel as a single signal. The demultiplexer 418 is connected to the digital video decoder 420 and to the system information (meta-data) block 432. The data stream from the demultiplexer 418 is decoded by the digital video decoder 420, and then converted into the appropriate information and control signals to drive a television display 424. The output of the digital video decoder 420 is connected to the frame buffer 422, which is configured and disposed to output the proper signals to the display 424. In addition to the in-band tuner 412, there is also an out-of-band tuner 426 which is also electrically connected to the antenna 410. The RF signal that is received by the antenna 410, also includes an out-of-band signal. The out-of-band signal contains information such as the channel map, channel program description, specific channels that are authorized for a specific user, etc. The out-of-band signal is demodulated by the out-of-band signal demodulator 428 which is configured and disposed to receive the output of the out-of-band tuner 426. The out-of-band signal is then decoded by the out-of-band signal decoder 430 which is connected to the output of the out-of-band signal demodulator 428. The out-of-band signal information is then fed into the system information (meta-data) 432. The system information (meta-data) block 432 is also connected as an input to the demultiplexer 418.

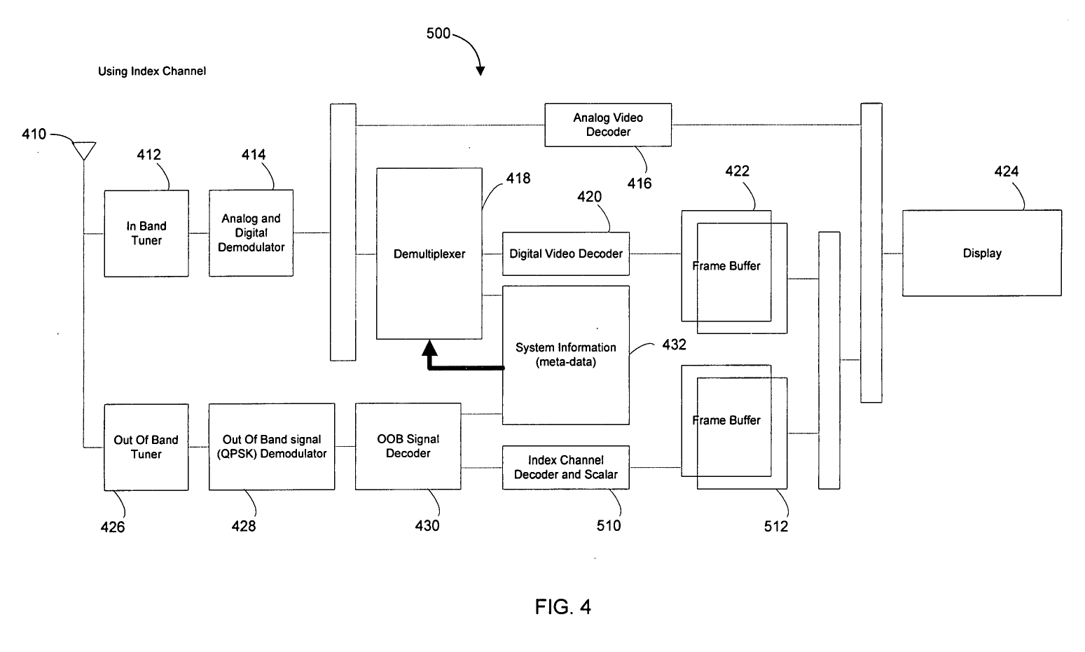

Referring to FIG. 4, a high-level functional block diagram of a digital television receiving/decoding section 500 that utilizes an index channel 20 is shown. The receiving/decoding section 500 includes an antenna 410, an in-band tuner 412, an analog and digital demodulator 414, an analog video decoder 416, a demultiplexer 418, a digital video decoder 420, a frame buffer 422, a display 424, an out of band tuner 426, an out of band signal demodulator 428, an out of band (OOB) signal decoder 430, a system information (meta-data) block 432, an index channel decoder and scalar 510, and a second frame buffer 512. A RF signal representing an MPEG data stream, is received by the antenna 410, which is electrically connected to the in-band tuner 412. Although the antenna 410 and tuner 412 are shown as receiving a broadcast digital television signal, the tuner 412 may receive cable signals or signals from a satellite receiver. The data stream is demodulated by an analog and digital demodulator 414 which is electrically connected to the output of the in-band tuner 412. The demodulator 414 is connected through a switch to both the demultiplexer 418 and the analog video decoder 416. The demultiplexer 418 is a device that separates signals that have been combined by a multiplexer for transmission over a communications channel as a single signal. The demultiplexer 418 is connected to the digital video decoder 420 and to the system information (meta-data) block 432. The data stream from the demultiplexer 418 is decoded by a digital video decoder 420, and then converted into the appropriate information and control signals to drive a television display 424. The output of the digital video decoder 420 is connected to the frame buffer 420, which is configured and disposed to output the proper signals to the display 424. In addition to the in-band tuner 412, there is also an out-of-band tuner 426 which is also electrically connected to the antenna 410. The RF signal that is received by the antenna 410, also includes an out-of-band signal. The out-of-band signal includes the index channel 20. The out-of-band signal is demodulated by the out-of-band signal demodulator 428 which is configured and disposed to receive the output of the out-of-band tuner 426. The out-of-band signal is then decoded by the out-of-band signal decoder 430 which is connected to the output of the out-of-band signal demodulator 428. The out-of-band signal information including the index channel meta-data is then fed into the system information (meta-data) 432. An index channel decoder and scalar 510 decodes the index channel 20 from the out-of-band signal into a frame buffer 512, as described below in stage 210 of the process 200 for receiving the index channel 20.

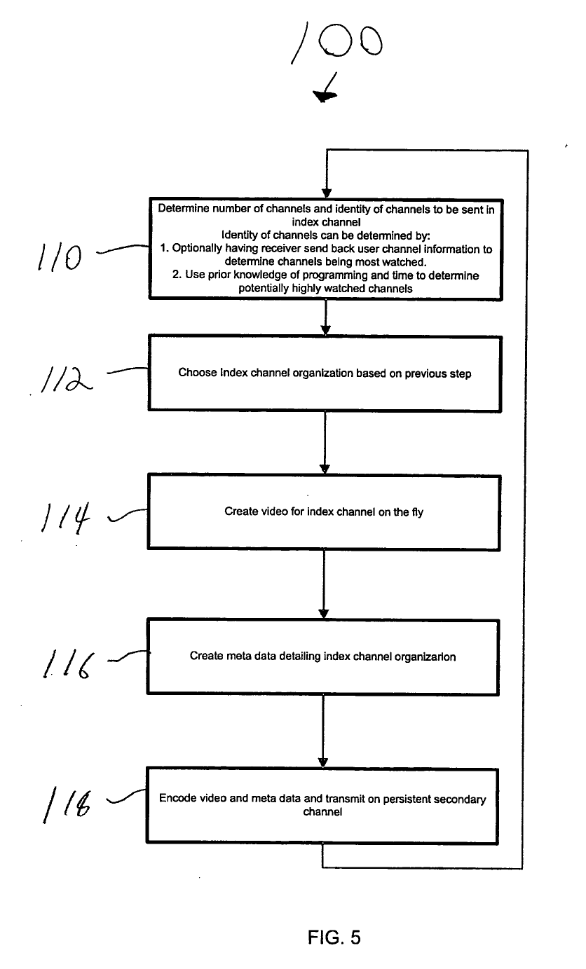

Referring to FIG. 5, with further reference to FIGS. 1 and 2, a process 100 for providing the index channel 20 includes the stages shown. The process 100 is exemplary only and not limiting. The process 100 may be modified, e.g., by adding, removing, or rearranging the stages shown.

At stage 110, the process 100 determines the number and identity of channels to be sent in the index channel 20. Two exemplary but not limiting methods that could be used by the process 100 to determine the channels to be included in the index channel 20 are as follows: first the digital television receiver could send back user channel information to determine channels being most watched by a specific user, and second, the index channel provider could use prior knowledge of programming and time to determine potentially highly watched channels. Depending on the total number of channels available to a user and the total available bandwidth for the index channel 20, substantially all the available channels could be indexed on the index channel 20.

At stage 112, the process 100 determines an index channel organization based upon input from the previous stage. The index channel organization includes factors such as location, and size of the channels on the index channel 20. The index channel organization determines the identity of the first broadcast channel video that will reside in the first sub-frame 22 of the index channel 20. The index channel organization stage 112 also determines the required aspect ratios in order to fit the required number of video channels onto the index channel 20. The organization stage 112 also determines the positioning of the sub-frames within the index channel 20 if the sub-frames are specified to have variable aspect ratios according to certain criteria as identified in a previous stage.

At stage 114, the process 100 creates video for the index dynamically while the process 100 is ongoing. This is done by scaling the original video signals to the appropriate size to fit within the sub-frames (e.g. 22) of the index channel and also reducing the resolution of the original video.

At stage 116, the process 100 creates meta-data that describes the index channel organization. This is done with information from previous stage 112. This meta-data becomes a type of map for the receiving device to determine the identity of the video contained within each sub-frame (e.g. 22, 24, 26) of the index channel 20. The meta-data also relays any necessary aspect ratio or size information for the sub-frames of the index channel 20 including whether is a variable aspect ratio organization. The meta-data is configured such that it can be encoded and transmitted with the video in a subsequent stage.

At stage 118, the process 100 encodes the video of the sub-frames of the index channel 20 and meta-data created in stage 116 and transmits both on a persistent secondary channel.

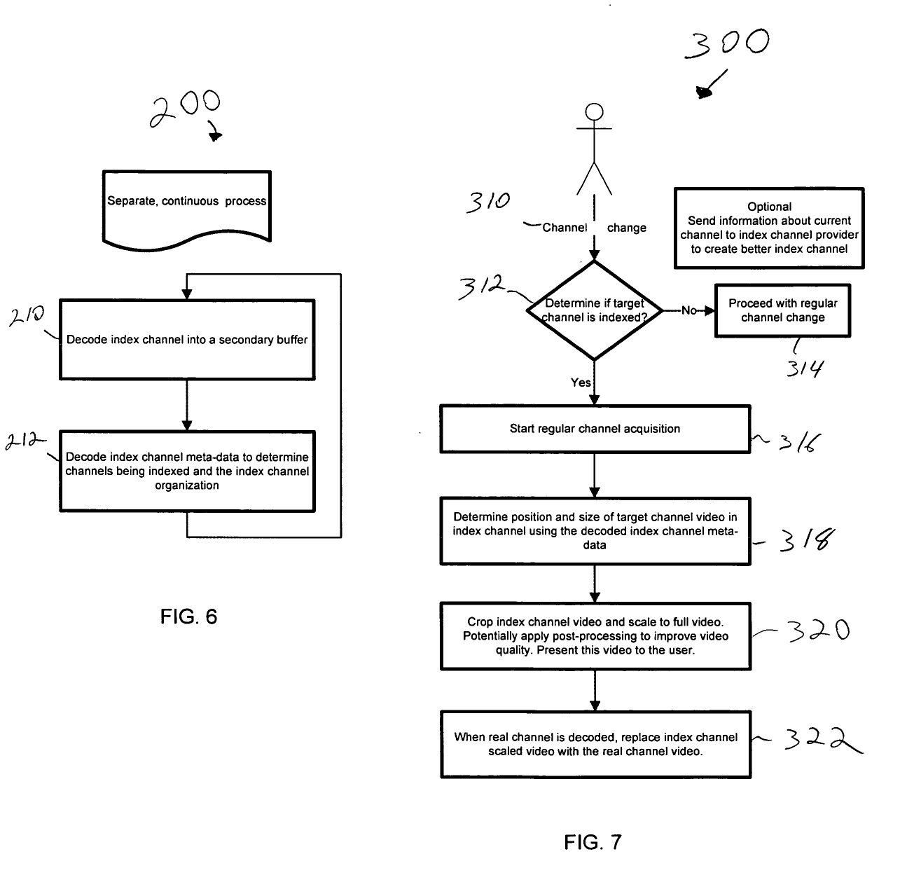

Referring to FIG. 6, with further reference to FIGS. 2, 4, 9, and 10, a process 200 for receiving the index channel 20 includes the stages shown. The process 200 is exemplary only and not limiting. The process 200 may be modified, e.g., by adding, removing, or rearranging the stages shown. The process 200 is preferably performed as a separate, continuous process from the viewing and changing of a regular digital television channel.

The process 200 includes stage 210 in which the index channel 20 is decoded into a secondary buffer. Stage 210 is implemented in FIGS. 4, 9, and 10 by an index channel decoder and scalar 510, and a frame buffer 512.

At Stage 212, the system 500 decodes the index channel meta-data that is transmitted on the persistent secondary channel along with the images on the index channel 20 to determine which channels are indexed and the index channel organization.

Referring to FIG. 7, with further reference to FIGS. 2, 4, 9, and 10, a process 300 for implementing a channel change that reduces the perceived channel change time by utilizing the index channel 20 includes the stages shown. The process 300 is exemplary only and not limiting. The process 300 may be modified, e.g., by adding, removing, or rearranging the stages shown.

The process 300 is preferably performed upon a viewer request for a channel change 310. At stage 312, the process determines if the target channel is indexed on the index channel 20. Depending on whether the system 500 determines that the target channel is or is not indexed, the process 300 proceeds to stage 316, or 314 respectively. At stage 314, if the target channel is not indexed, the system 500 proceeds with a regular digital TV channel change. At stage 316, the process starts the regular channel acquisition which utilizes an in band tuner 412, an analog and digital demodulator 414, a demultiplexer 418, a digital video decoder 420, and a frame buffer 422.

At stage 318, the system 500 determines the position and size of the target channel video within the index channel 20 using the decoded index channel meta-data from the system information 432.

At stage 320, the process crops the target channel video from the index channel 20, and scales the target channel video to full video display size. Any post processing that may be necessary to improve video quality is also performed at this stage. The full size video from the index channel is then presented to the user through the TV display 424.

At stage 322, once the regular channel whose acquisition was started in stage 316 is decoded, the index channel scaled video is replaced with the regular channel video.

Other embodiments are within the scope of the invention.

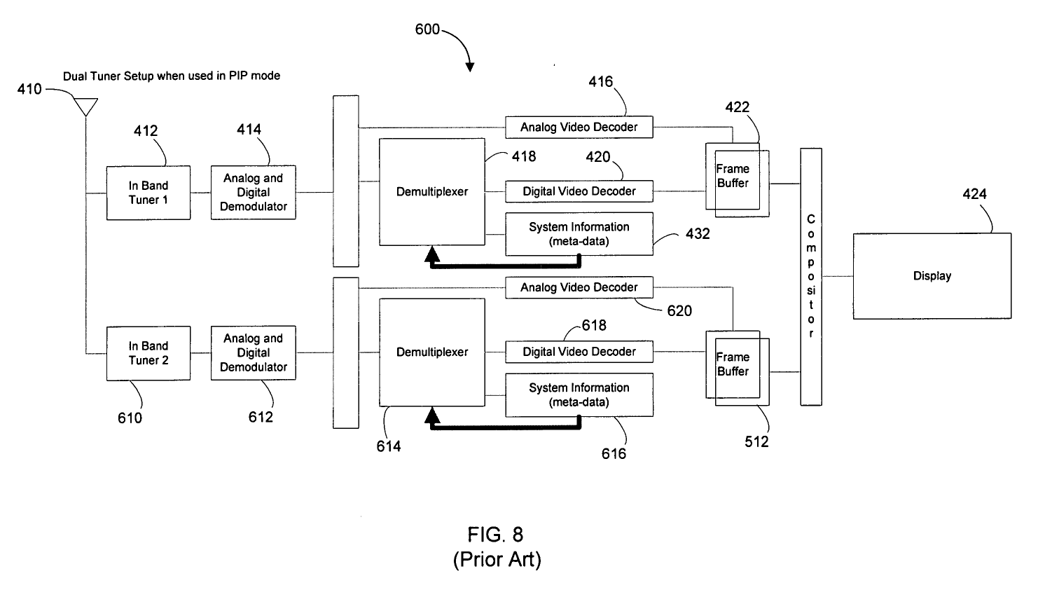

Referring to FIG. 8, a high-level functional block diagram of a conventional digital television receiving/decoding section 600 is shown that utilizes a dual tuner setup for a picture-within-a-picture mode capability. The conventional dual tuner digital television receiving/decoding section 600 includes an antenna 410, an in-band tuner 412, an analog and digital demodulator 414, an analog video decoder 416, a demultiplexer 418, a digital video decoder 420, a frame buffer 422, a display 424, a system information (meta-data) block 432, a second in-band tuner 610, a second analog and digital demodulator 612, a second demultiplexer 614, a second system information (meta-data) block 616, a second digital video decoder 618, a second analog video decoder 620, and a second frame buffer 512.

A second RF signal representing an MPEG data stream, is received by the antenna 410 and the second in-band tuner 610 which is electrically connected to the antenna 410. Although the antenna 410 and tuner 610 are shown as receiving a broadcast digital television signal, the tuner 610 may receive cable signals or signals from a satellite receiver. The second data stream is demodulated by the second analog and digital demodulator 612 which is configured and connected to the output of the tuner 610. The output of the demodulator 612 is connected through a switch to the second demultiplexer 614 and to the second analog video decoder 620. The demultiplexer 614 is connected to the digital video decoder 618 and the system information (meta-data) block 616. The second data stream output from the demultiplexer 614 is decoded by the digital video decoder 618, and then converted into the appropriate information and control signals to drive a television display 424. The output of the digital video decoder 618 is connected to the second frame buffer 512, which is configured and disposed to output the proper signals to the display 424.

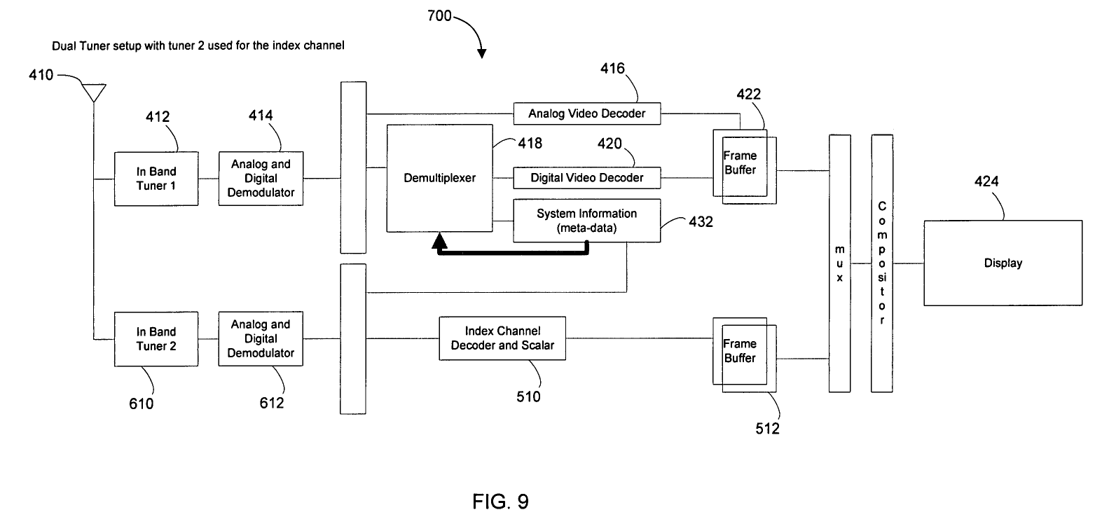

In an alternative embodiment shown in FIG. 9, a high-level functional block diagram of a digital television receiving/decoding section 700 that utilizes a dual tuner setup for an index channel 20 is shown. The digital television receiving/decoding section 700 includes an antenna 410, an in-band tuner 412, an analog and digital demodulator 414, an analog video decoder 416, a demultiplexer 418, a digital video decoder 420, a frame buffer 422, a display 424, a system information (meta-data) block 432, a second in-band tuner 610, a second analog and digital demodulator 612, an index channel decoder and scalar 510, and a second frame buffer 512.

A second RF signal representing an MPEG data stream, is received by the antenna 410, and the second in-band tuner 610 that is connected to the antenna 410. Although the antenna 410 and tuner 610 are shown as receiving a broadcast digital television signal, the tuner 610 may receive cable signals or signals from a satellite receiver. The second data stream is demodulated by the analog and digital demodulator 612. The demodulator 612 is connected to receive the output of the tuner 610. The second data stream includes the index channel 20. The output of the demodulator is connected through a switch to the system information block 432 and to the index channel decoder and scalar 510. The second data stream information including the index channel meta-data is then fed into the system information (meta-data) 432. The index channel decoder and scalar 510 decodes the index channel 20 from the second data stream into a frame buffer 512, as described in stage 210 of the process 200 for receiving the index channel 20.

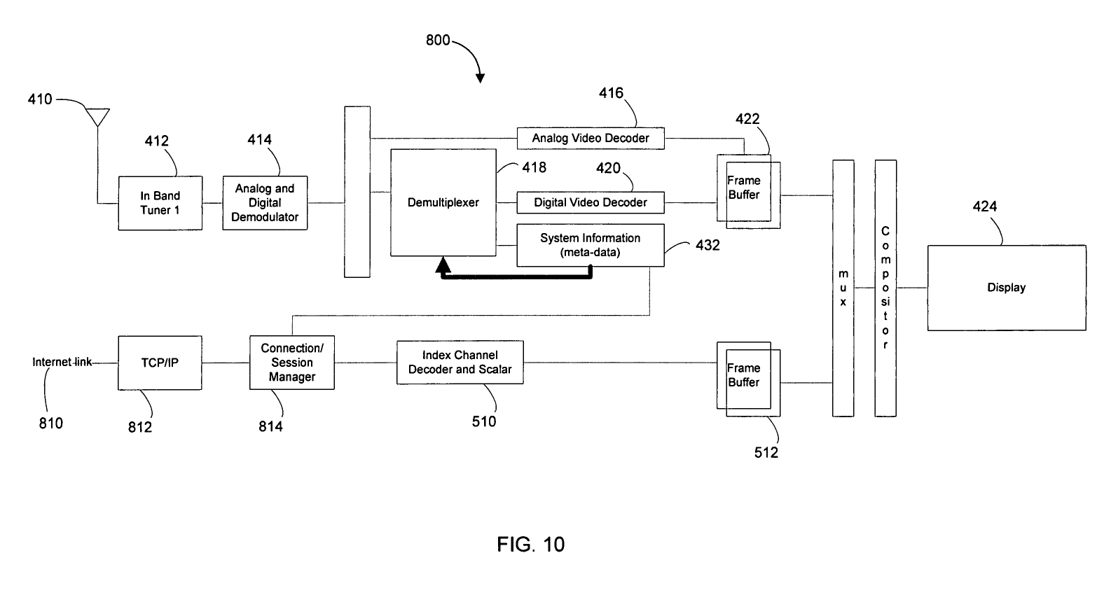

In another alternative embodiment shown in FIG. 10, a high-level functional block diagram of a digital television receiving/decoding section 800 that utilizes an internet link for an index channel 20 is shown. The digital television receiving/decoding section 800 includes an antenna 410, an in-band tuner 412, an analog and digital demodulator 414, an analog video decoder 416, a demultiplexer 418, a digital video decoder 420, a frame buffer 422, a display 424, a system information (meta-data) block 432, an internet link 810, a transmission control protocol/internet protocol (TCP/IP) port 812, a connection/session manager 814, an index channel decoder and scalar 510, and a second frame buffer 512.

The internet link 810 is utilized to provide a data stream which includes an index channel 20 and index channel meta-data to the transmission control protocol/internet protocol (TCP/IP) port 812 on the digital television receiving/decoding section 800. The connection/session manager 814 is configured to receive and control the data stream from the internet through the TCP/IP port 812. The outputs of the connection/session manager 814 are connected to the system information 432 and to the index channel decoder and scalar 510. The index channel meta-data is sent to the system information (meta-data) 432. The index channel decoder and scalar 510 decodes the index channel 20 from the connection/session manager 814 into the second frame buffer 512, as described in stage 210 of the process 200 for receiving the index channel 20.

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

A “signal” or “stream” may be modified by a component and referred to herein (in the description and/or claims) as “the signal” or “the stream” both before and after the modification. For example, a “stream” or “signal” that is provided by a tuner to a processor module can be modified by intervening components (e.g., a modulator) and still be referred to as “the stream” or “the signal” before and after the tuner, the intervening components, and the processor module.

Further, while the description above refers to the invention, more than one invention may be described.

What is claimed is:

1. A digital television receiver system for reducing the perceived channel change time in digital television systems, the system comprising:
a means for decoding a primary digital video signal that is a component of a composite signal, the primary signal having a first frequency in any of a plurality of bands of frequencies for conveying the composite signal which contains a plurality of component digital video signals each including a primary image stream;
a means for decoding a supplemental digital video signal including indicia of the image streams of the plurality of component digital video signals, the supplemental signal being at least one of the following: of a second frequency in the plurality of bands of frequencies, of a second frequency outside the plurality of bands of frequencies, and of a form for transfer in a packet-switched network; and
a means for selecting and displaying a portion of the indicia corresponding to one of the image streams from the supplemental signal corresponding to a newly requested one of the component video signals.

2. The system of claim 1 wherein the means for displaying is configured to display the selected image stream during a delay time between when a new primary signal is selected to when a digital signal is acquired, decoded and displayed.

3. The system of claim 1 wherein the indicia of the image streams are indicative of supplemental images of lower resolution than primary images indicated by the primary image streams, and the means for displaying is configured to size the images corresponding to the selected supplemental image stream similarly to a size of the primary images.

4. The system of claim 1 wherein the means for decoding the supplemental signal is configured to persistently receive and decode the supplemental signal.

5. A method for reducing the perceived channel change time in digital televisions systems, the method comprising:
receiving and decoding a plurality of video streams each comprising a series of first images, the video streams being of frequencies in different frequency bands of available first frequency bands;
receiving video stream indicia of the plurality of the video streams, the video stream indicia having characteristics other than having multiple frequencies in the available first frequency bands; and
responding to a digital video stream change request by selecting a portion of the indicia corresponding to a newly requested video stream and displaying video corresponding to the selected portion of the indicia during at least a portion of a delay time from when the new video stream is selected to when that stream is acquired, decoded and displayed.

6. The method of claim 5 further comprising decoding the video stream indicia of a frequency within the available primary frequency bands.

7. The method of claim 5 further comprising decoding the video stream indicia of a frequency of an out-of-band frequency range.

8. The method of claim 5 wherein receiving the video stream indicia comprises receiving the video stream indicia via a packet-switched network connection and decoding the video stream indicia comprises decoding packets of information in the video stream indicia.

9. The method of claim 8 wherein receiving the video stream indicia further comprises the packet switched network connection is a Transmission Control Protocol/Internet Protocol (TCP/IP) connection.

10. The method of claim 5 wherein the indicia of the plurality of video streams are indicative of images that are of lower video resolution than the first images indicated by the plurality of video streams.

11. The method of claim 10 wherein the video stream indicia corresponding to a newly requested video stream is cropped from the video stream indicia and scaled to substantially the same size as the requested video stream.

12. The method of claim 5 wherein receiving and decoding the video stream indicia are performed in an ongoing manner such that the indicia are available for selection substantially simultaneously with a new video stream being selected.

13. A digital television receiver system comprising:
a tuner configured to receive a digital data stream;
a digital demodulator coupled to the tuner and configured to demodulate the digital data stream received from the tuner;
a digital video decoder coupled to the demodulator and configured to decode the digital video data stream received from the digital demodulator;
a display coupled to the decoder and configured to receive the decoded video stream and present the video in a viewable format; and
a device coupled to the display and configured to respond to a digital television channel change indication to send to the display a lower resolution image stream of a new requested digital television channel while the tuner adjusts to a frequency of the new requested digital television channel and the decoder initially decodes the new requested digital television channel.

14. The system of claim 13 wherein the device is configured to process a persistent, dedicated signal to produce the lower resolution image stream.

15. The system of claim 14 wherein the device is configured to process the persistent dedicated signal with the persistent dedicated signal having an out-of-band frequency.

16. The system of claim 14 wherein the device is configured to process the persistent dedicated signal having an in-band frequency.

17. The system of claim 13 wherein the device is configured to process the lower resolution image stream received via a packet-switched network connection.

18. The system of claim 17 wherein the packet switched network connection is a Transmission Control Protocol/Internet Protocol (TCP/IP) connection.

19. The system of claim 14 wherein the device is configured to receive and decode the persistent, dedicated signal in a substantially continuous manner.
